(19) United States
(12) Patent Application Publication
(10) Pub. No.: US 2017/0247877 A1
(43) Pub. Date: Aug. 31, 2017

(54) METHOD FOR CONSTRUCTING CYLINDRICAL TANK

(71) Applicant: IHI Corporation, Tokyo (JP)

(72) Inventors: Juichiro YAMADA, Tokyo (JP); Shigeki KATO, Tokyo (JP)

(73) Assignee: IHI Corporation, Tokyo (JP)

(21) Appl. No.: 15/593,983

(22) Filed: May 12, 2017

Related U.S. Application Data
(63) Continuation of application No. PCT/JP2015/082428, filed on Nov. 18, 2015.

(30) Foreign Application Priority Data
Nov. 19, 2014 (JP) 2014-234550

(51) Int. Cl. E04B 1/35; E04H 7/06; F17C 1/02; E04H 7/20

(52) U.S. Cl. CPC E04B 1/3522; E04H 7/20; E04H 7/06; F17C 1/02; F17C 2201/0104; F17C 2203/011; F17C 2209/221; F17C 2221/033; F17C 2221/035; F17C 2203/0602

(57) ABSTRACT

A method for constructing a double-shell-structured cylindrical tank having an inner tank and an outer tank includes: a step of, inside the outer tank, assembling a first structure of the inner tank excluding a lowermost level of the inner tank by alternately and repeatedly performing raising of an inner tank lateral plate using a jack-up unit and attaching of a next inner tank lateral plate below the raised inner tank lateral plate; a step of assembling a second structure serving as the lowermost level of the inner tank on an annular portion provided on a base portion of the outer tank and configured to support the inner tank; and a step of assembling the inner tank by joining the first structure and the second structure.

### TECHNICAL FIELD

Embodiments described herein relates to a method for constructing a cylindrical tank.

This application is a continuation application based on a PCT Patent Application No. PCT/JP2015/082428, filed on Nov. 18, 2015, whose priority is claimed on Japanese Patent Application No. 2014-234550, filed on Nov. 19, 2014. The contents of both the PCT Application and the Japanese Application are incorporated herein by reference.

### BACKGROUND ART

Double-shell-structured cylindrical tanks having an inner tank and an outer tank are used for storing cryogenic liquids such as liquefied natural gas (LNG) and liquefied petroleum gas (LPG). Patent Document 1 discloses a method for constructing a cylindrical tank having an inner tank made of a metal and an outer tank made of concrete. In such a constructing method, the inner tank and the outer tank are constructed in parallel to shorten the construction period of the cylindrical tank.

To be specific, while sidewalls of the outer tank are sequentially built from the lowermost level to the uppermost level on a base portion of the outer tank of the cylindrical tank, jack-up units are supported by the sidewalls of the outer tank. Furthermore, raising of inner tank lateral plates using the jack-up units and welding of the next inner tank lateral plates below the raised inner tank lateral plates are alternately and repeatedly performed to sequentially attach the inner tank lateral plates from the uppermost level to the lowermost level. In this manner, the inner tank and the outer tank are constructed in parallel.

### CITATION LIST

### Patent Documents

[Patent Document 1]

Japanese Unexamined Patent Application, First Publication No. 2012-149416

### SUMMARY

In the above-described method in the related art, after inner tank lateral plates have been attached to the lowermost level, an inner tank is jacked down to be lowered on an annular portion provided at a base portion of an outer tank, and then anchor straps are welded to the inner tank. Thus, the inner tank is completed. After that, a cold insulation task is performed on a space between the inner and outer tanks. Therefore, in the method in the related art, a construction process until the inner tank is fixed onto the annular portion after the inner tank lateral plates are attached to the lowermost level is a critical path. For example, about one month is required to perform such construction and thus one objective is to shorten the construction period.

This disclosure was made in view of the above-described circumstances and has an object to provide a method for constructing a cylindrical tank in which fixing of an inner tank onto an annular portion is not a critical path and the construction period can be shortened.

A first aspect of this disclosure is a method for constructing a double-shell-structured cylindrical tank having an inner tank and an outer tank, the method for constructing the cylindrical tank including: a step of, inside the outer tank, assembling a first structure of the inner tank excluding a lowermost level of the inner tank by alternately and repeatedly performing raising of an inner tank lateral plate using a jack-up unit and attaching of a next inner tank lateral plate below the raised inner tank lateral plate; a step of assembling a second structure serving as the lowermost level of the inner tank on an annular portion provided on a base portion of the outer tank and configured to support the inner tank; and a step of assembling the inner tank by joining the first structure and the second structure.

In this disclosure, assembly of a second structure, which serves as the lower Host level of an inner tank, on a base portion of an outer tank is performed in parallel with assembly of a first structure of the inner tank excluding the lowermost level of the inner tank using a jack-up unit, and then joining of the first structure and the second structure is performed to assemble the inner tank. As described above, in this disclosure, since assembly of the lowermost level of the inner tank is separated from assembly of the inner tank using the jack-up unit, fixing of the lowermost level of the inner tank onto an annular portion can be performed ahead of schedule.

Therefore, according to this disclosure, fixing of the inner tank onto the annular portion is not a critical path, and thus the construction period can be shortened.

### BRIEF DESCRIPTION OF DRAWINGS

FIG. 1 is diagram showing steps of a constructing method according to a first embodiment of this disclosure.

FIG. 2 is a diagram showing steps of the constructing method according to the first embodiment of this disclosure.

FIG. 3 is a diagram showing steps of the constructing method according to the first embodiment of this disclosure.

FIG. 4 is a diagram showing steps of the constructing method according to the first embodiment of this disclosure.

FIG. 5 is a side view showing a conveying device and a lifting device according to the first embodiment of this disclosure.

FIG. 6 is a view in a direction of an arrow A shown in FIG. 5.

FIG. 7 is a plan view showing the conveying device and the lifting device according to the first embodiment of this disclosure.

FIG. 8 is a diagram showing steps of a constructing method according to a second embodiment of this disclosure.

FIG. 9 is a diagram showing steps of the constructing method according to the second embodiment of this disclosure.

FIG. 10 is a diagram showing steps of the constructing method according to the second embodiment of this disclosure.

FIG. 11 is a diagram showing steps of the constructing method according to the second embodiment of this disclosure.

FIG. 12 is a diagram showing steps of the constructing method according to the second embodiment of this disclosure.

FIG. 13 is a diagram showing steps of the constructing method according to the second embodiment of this disclosure.

FIG. 14 is a diagram showing steps of the constructing method according to the second embodiment of this disclosure.

FIG. 15 is a diagram showing steps of the constructing method according to the second embodiment of this disclosure.

FIG. 16 is a diagram showing steps of the constructing method according to the second embodiment of this disclosure.

FIG. 17 is a diagram showing steps of the constructing method according to the second embodiment of this disclosure.

FIG. 18 is a diagram showing steps of the constructing method according to the second embodiment of this disclosure.

### DESCRIPTION OF EMBODIMENTS

Hereinafter, a method for constructing a cylindrical tank of this disclosure will be described with reference to the drawings. In the following description, as a cylindrical tank, a ground-type prestressed concrete (PC) double-shell storage tank configured to store liquefied natural gas (LNG) is used as an exemplary example.

### First Embodiment

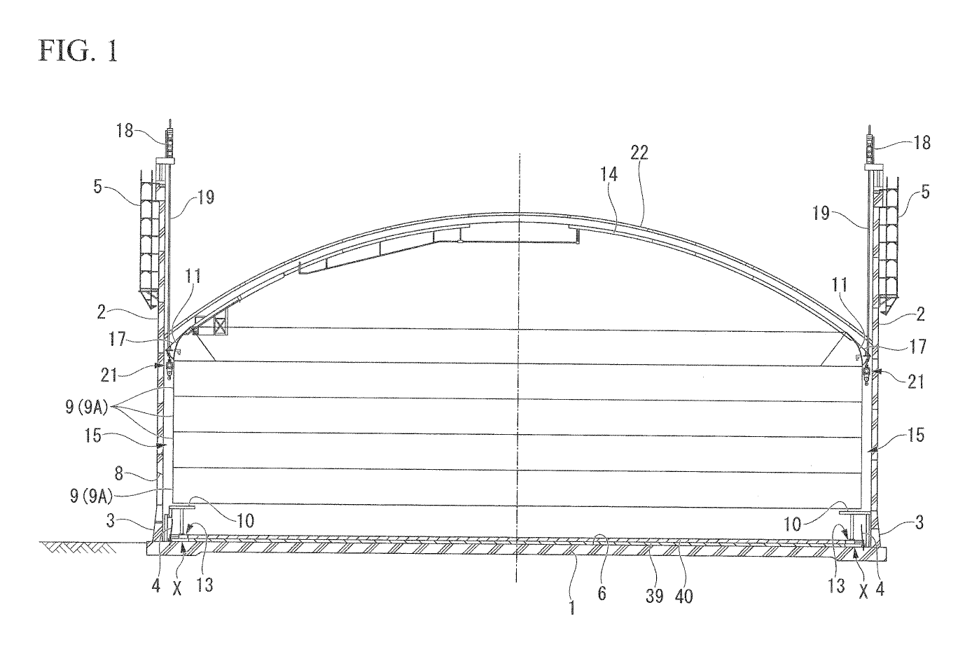

As shown in FIG. 1, in this method, first, a substantially disc-shaped base slab 1 (a base portion of an outer tank) is constructed. On an outer peripheral edge portion of the base slab 1, there is erected a base portion 3 on which a PC wall 2 (outer tank) is to be assembled. Inner tank anchor straps 4 are installed along an inside of the base portion 3. Then, the PC wall 2 is formed on the base part 3 by pouring concrete. For the formation of the PC wall 2 by pouring concrete, foot scaffolds 5 are provided, and molds (not shown in the figure) are installed.

Subsequently, a bottom liner 6 is laid on the base slab 1. Furthermore, a construction site entrance 8 into which inner tank lateral plates 9 are loaded one by one is formed at a base end portion of the PC wall 2. A plurality of portal stands 10 for assembling the inner tank lateral plates are installed along an inside of the base end portion of the PC wall 2. The portal stands 10 are installed to cross over an annular region X of the base slab 1, the annular region X being a region on which a cylindrical inner tank obtained by assembling the plurality of inner tank lateral plates 9 should be finally lowered.

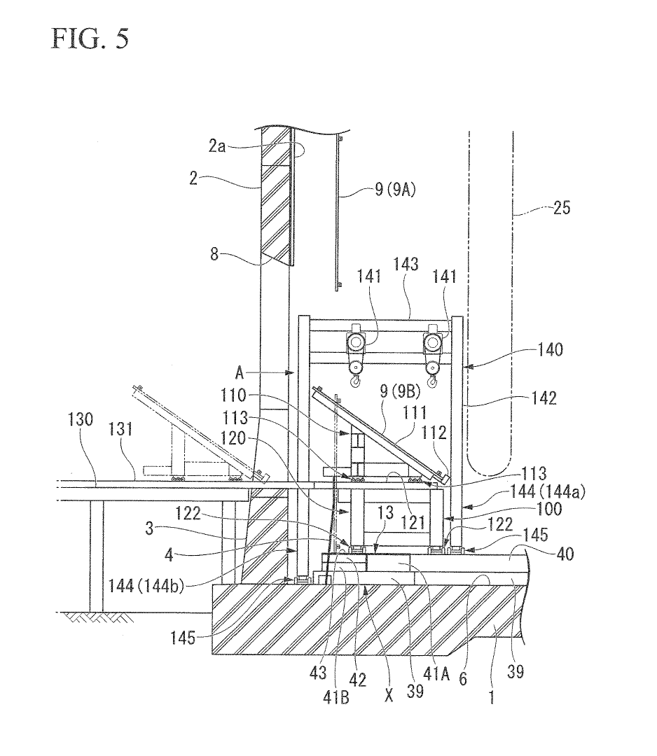

A cold insulation task on an annular portion 13 is performed under the portal stands 10. As shown in FIG. 5 which will be described later, the cold insulation task on the annular portion 13 includes assembling perlite concrete blocks 41A and 41B and structural lightweight concrete blocks 42 on a bottom cold-resistant relaxation member 39 and attaching an annular plate 43 to the top thereof. The annular portion 13 is a part configured to finally support the assembled inner tank lateral plates 9. Thus, the annular plate 43 is foamed to be thick and a cold insulation structure for the annular portion 13 is formed of a rigid material such as concrete blocks.

After the cold insulation task on the annular portion 13 has been completed, leg portions, which have been arranged in an area of the tank more inner than the annular portion 13, are relocated on the annular portion 13. With this relocation, no obstacle is present in the area of the tank inner than the annular portion 13. Thus, the cold insulation task can be performed on a central portion of the base slab 1. As shown in FIG. 1, in the cold insulation task on the central portion, cellular glass 40 is placed on the bottom cold-resistant relaxation member 39. Furthermore, perlite concrete blocks (not shown in the figure) and an inner tank bottom plate (not shown in the figure) are laid thereon in this order.

Also, in this method, in parallel with the above-described cold insulation task, the inner tank lateral plates 9 are placed on the portal stands 10, the adjacent inner tank lateral plates 9 are welded, and thus the inner tank lateral plates 9 are joined together in a circumferential direction thereof to be cylindrical as a whole. Furthermore, knuckle plates 11 are assembled to upper ends of the inner tank lateral plates 9. An inner tank roof 14 is assembled on a roof stand (not shown in the figure) which has been built on the central portion of the base slab 1 before the cold insulation task on the central portion is performed, and the inner tank lateral plates 9 are fixed to an outer peripheral edge portion of the inner tank roof 14 via the knuckle plates 11.

Subsequently, in this method, a plurality of jack-up units 18 are installed at the PC wall 2 in the tank circumferential direction. Furthermore, a plurality of knuckle reinforcements 17 corresponding to the plurality of jack-up units 18 are installed at the knuckle plates 11. The knuckle reinforcements 17 protrude from the knuckle plates 11 toward a space 15 between inner and outer tanks. The knuckle reinforcements 17 serve as hanged-side stands. The jack-up units 18 are center hall jacks and lower ends of jack-up rods 19 are attached to the knuckle reinforcements 17.

After the jack-up units 18 are installed as described above, the roof stand (not shown in the figure) is removed and the knuckle plates 11 are lifted using the jack-up units 18 to raise the inner tank lateral plates 9. After the knuckle plates 11 are raised by the jack-up units 18 by a single stroke of the jack-up rod 19 (corresponding to a vertical width of a single inner tank lateral plate 9 in this embodiment), the next inner tank lateral plates 9 are loaded into a space formed below the jacked-up inner tank lateral plates 9.

The next inner tank lateral plates 9 are lifted using trolley cranes 21 provided in the space 15 between inner and outer tanks and are conveyed to a predetermined weld position. On the portal stands 10, the plurality of inner tank lateral plates 9 which are annularly disposed are welded to each other and the inner tank lateral plates 9 which are vertically arranged are welded to each other, thereby the inner tank lateral plates 9 are formed in an integral cylindrical shape. By alternately and repeatedly performing the raising of the inner tank lateral plates 9 using the jack-up units 18 and the attaching of the next inner tank lateral plates 9 below the raised inner tank lateral plates 9, the inner tank lateral plates 9 are sequentially attached from the uppermost level. Thus, a first structure 9A of the inner tank lateral plates 9 excluding the lower lost level is assembled.

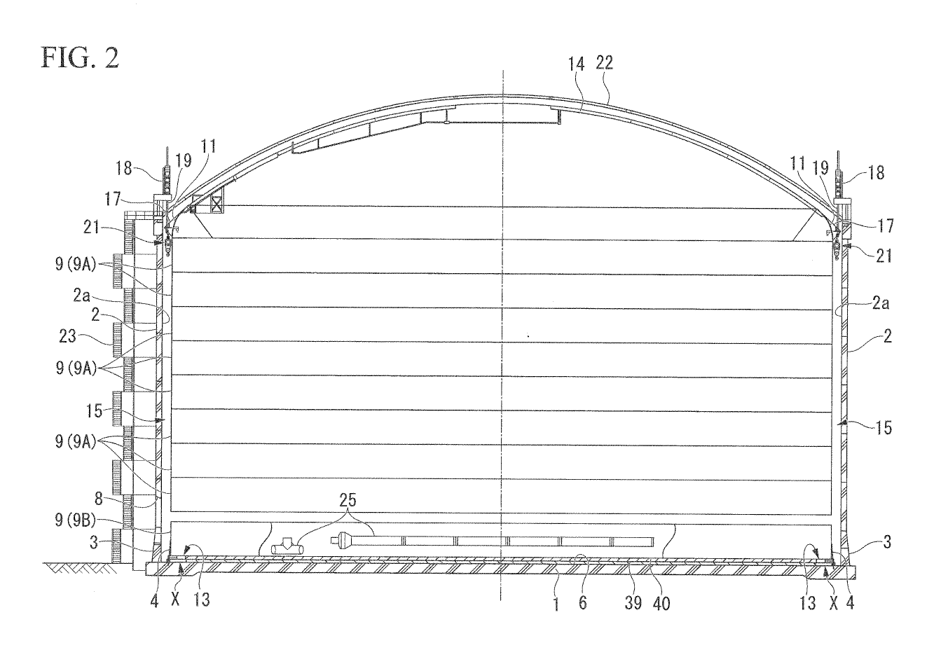

On the other hand, as shown in FIG. 2, the inner tank lateral plates 9 in the lowermost level are assembled on the annular portion 13 separately from the first structure 9A. After the inner tank lateral plates 9 in the lowermost level is placed on the annular portion 13, the adjacent inner tank lateral plates 9 are welded and thus the inner tank lateral plates 9 are joined together in the circumferential direction to be cylindrical as a whole. Thus, a second structure 9B is assembled. After the second structure 9B has been assembled, the inner tank anchor straps 4 installed at the base slab 1 are attached to the second structure 9B.

Also, as shown in FIG. 2, an outer tank roof 22 is assembled on the inner tank roof 14. The outer tank roof 22 is connected to the inner tank roof 14 using connecting members (not shown in the figure) and is formed integrally with the inner tank roof 14. Furthermore, a lateral liner 2a is bonded to an inner wall surface of the PC wall 2. A staircase 23 is provided on the outside of the PC wall 2. A pump well 25 is loaded inside the PC wall 2.

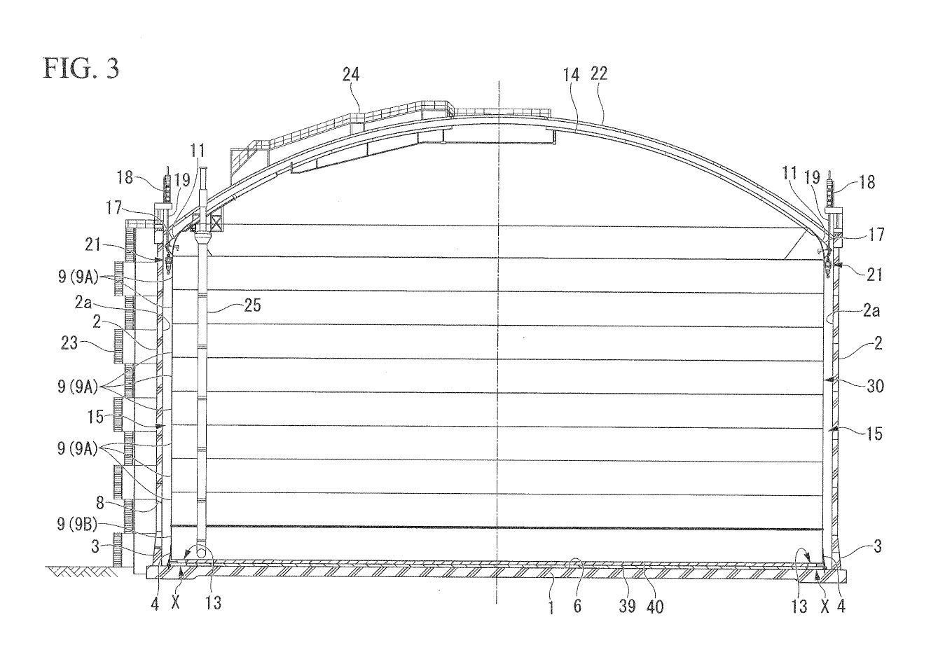

Subsequently, as shown in FIG. 3, the first structure 9A is jacked down so that a lower end of the first structure 9A is lowered on an upper end of the second structure 9B, the first structure 9A is welded with the second structure 9B, and thus an inner tank 30 is assembled. In this method, assembly of the lowermost level of the inner tank 30 is separated from assembly of the inner tank 30 using the jack-up units 18, and fixing of the second structure 9B serving as the lowermost level of the inner tank 30 onto the annular portion 13 is performed ahead of schedule (refer to FIG. 2). Therefore, in this method, fixing of the inner tank 30 onto the annular portion 13, which takes about, for example, one month, is not a critical path, and thus the construction period can be shortened as compared with a method in the related art.

After the inner tank 30 has been completed, connection between the outer tank roof 22 and the inner tank roof 14 using the connecting members (not shown in the figure) is released and the outer tank roof 22 is settled on the upper end of the PC wall 2 that has been assembled to its uppermost level. Furthermore, a roof staircase 24 is provided at the outer tank roof 22. The pump well 25 is installed.

Subsequently, the knuckle reinforcements 17 are cut off and the jack-up units 18 are removed. After that, a tension task is performed on the PC wall 2. Then, after the construction site entrance 8 is closed, a pressure resistance/air-tightness test is performed by filling the tank with water.

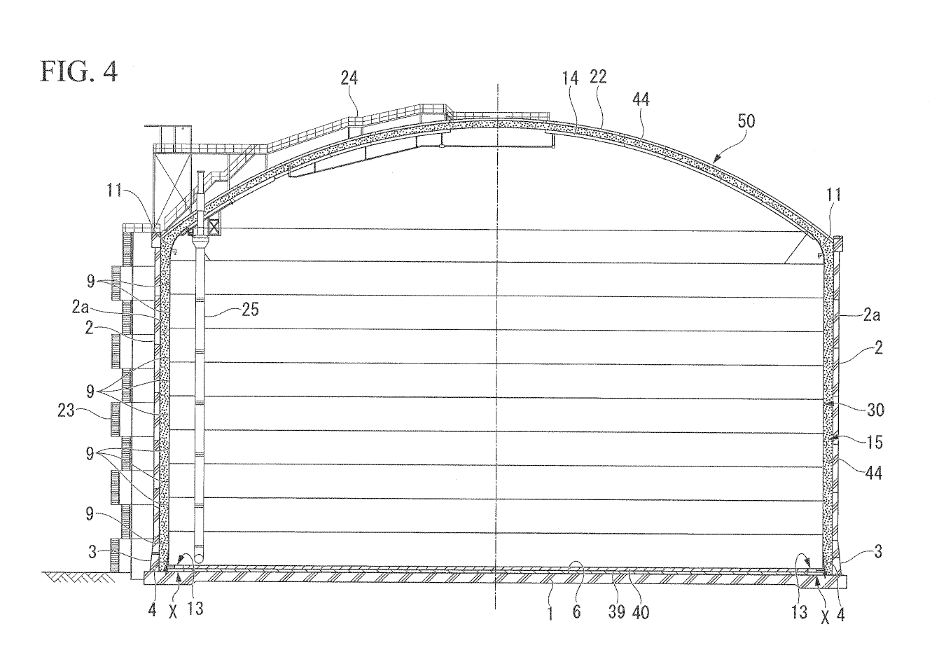

Finally, as shown in FIG. 4, a cold insulation material 44 is arranged in the space 15 between inner and outer tanks, and the cold insulation material 44 is also arranged on the rear side of the inner tank roof 14. Thus, cold insulation task is performed. After that, through a painting task and a piping cold insulation task, construction of a cylindrical tank 50 is completed.

As described above, this embodiment is a method for constructing the double-shell-structured cylindrical tank 50 having the inner tank and the outer tank, and the method includes: a step of, inside the PC wall 2, assembling the first structure 9A of the inner tank 30 excluding the lowermost level of the inner tank 30 by alternately and repeatedly performing raising of the inner tank lateral plates 9 using the jack-up units 18 and attaching of the next inner tank lateral plates 9 below the raised inner tank lateral plates 9; a step of assembling the second structure 9B serving as the lowermost level of the inner tank 30 on the annular portion 13 provided on the base slab 1 and configured to support the inner tank 30; and a step of assembling the inner tank 30 by joining the first structure 9A and the second structure 9B. Thus, since fixing of the lowermost level of the inner tank 30 onto the annular portion 13 can be performed ahead of schedule, fixing of the inner tank 30 onto the annular portion 13 is not a critical path, and thus the construction period can be shortened.

Note that, as a method of assembling the second structure 9B, the following methods shown in FIGS. 5 to 7 can be used.

In this method, assembly of the lowermost level of the inner tank 30 is separated from assembly of the inner tank 30 using the jack-up units 18. Thus, the assembly of the first structure 9A and the assembly of the second structure 9B can be performed in parallel. In this case, the inner tank lateral plates 9 of the second structure 9B need to be conveyed in the tank circumferential direction using a device separately from the trolley cranes 21 for conveying the inner tank lateral plates 9 of the first structure 9A in the tank circumferential direction. In this method, as shown in FIG. 5, a conveying device 100 configured to travel on the ground is provided and is used for conveying the inner tank lateral plates 9 of the second structure 9B in the tank circumferential direction.

The conveying device 100 can be separated into an upper stand 110 and a lower stand 120. The upper stand 110 has a supporting part 111 configured to support the inner tank lateral plates 9 of the second structure 9B. The supporting part 111 is inclined, has a horizontal member 112 at a lower end thereof, and diagonally supports the inner tank lateral plates 9. With such a constitution, since the inner tank lateral plates 9 are not laid horizontally, interference of the inner tank lateral plates 9 with the pump well 25 or the like can be avoided. Furthermore, with such a constitution, since the inner tank lateral plates 9 do not stand vertically, interference of the inner tank lateral plates 9 of the second structure 9B with the inner tank lateral plates 9 or the like of the lifted first structure 9A can be avoided.

The upper stand 110 has rollers 113, and thus configured to be movable to an inside or an outside of the PC wall 2 via the construction site entrance 8. Outside the PC wall 2, an outer stand 130 configured to receive the inner tank lateral plates 9 is provided and rails 131 are laid on the outer stand 130. Inside the PC wall 2, the lower stand 120 is provided and rails 121 which can be connected to the rails 131 are laid on the lower stand 120. Thus, the rollers 113 can be moved between the rails 131 and the rails 121, and the upper stand 110 which has received the inner tank lateral plates 9 outside of the PC wall 2 can be moved to an area above the lower stand 120.

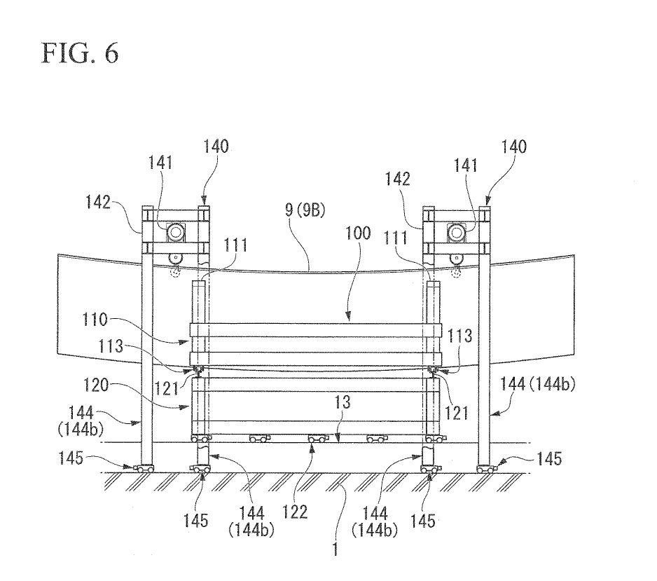

The lower stand 120 has rollers 122 which can travel on the base slab 1 which has subjected to the cold insulation task. The lower stand 120 can move using the rollers 122 in the tank circumferential direction. The rollers 122 are grounded at the annular portion 13 and at an area more inner than the annular portion 13. As shown in FIG. 6, the plurality of rollers 122 are provided at the lower stand 120 so that a local load is not applied to the cold insulation structure for the annular portion 13 and the like. As such rollers 113, for example, plural-row roller units having five or more rows for each unit may be adopted.

In this method, the assembly of the first structure 9A and the assembly of the second structure 9B are performed in parallel. Thus, the inner tank lateral plates 9 of the second structure 9B which are diagonally supported need to be vertically raised using a device separately from the trolley cranes 21. As shown in FIG. 5, lifting devices 140 configured to travel on the ground are provided and stand the inner tank lateral plates 9 of the second structure 9B on the annular portion 13.

The lifting devices 140 have, for example, trolley cranes 141 configured to lift the inner tank lateral plates 9. The trolley cranes 141 are mounted on a movable stand 142. The movable stand 142 is formed in a gate type to cross over a traveling route of the conveying device 100. With such a constitution, interference of the lifting devices 140 with the conveying device 100 can be avoided and the lifting devices 140 can move independently of the conveying device 100. As a result, for example, after lifting (raising) of a specific inner tank lateral plate 9 has been completed, the lifting device 140 for the specific inner tank lateral plate 9 can be moved to a place where the next inner tank lateral plate 9 is to be lifted. Thus, the number of lifting devices 140 can be reduced, and efficiency in the assembly of the second structure 9B can be improved.

As shown in FIGS. 5 and 6, leg portions 144 of the movable stand 142 are grounded at an inside and an outside of the annular portion 13 via rollers 145 so that the movable stand 142 crosses over the annular portion 13. In the leg portion 144, a leg portion 144b disposed at an area more outer than the annular portion 13 is formed to be longer than a leg portion 144a disposed at an area more inner than the annular portion 13. With such a constitution, the leg portion 144b disposed at the area more outer than the annular portion 13 can travel on the base slab 1 which is lowered one step. Thus, an interval between the inner and outer leg portions 144 can be widely secured and thus interference of the lifting devices 140 with the conveying device 100 can be more reliably avoided. Note that plural-row roller units may be also adopted for the rollers 145 so that a load is distributed, and thus a local load with respect to the cold insulation structure and the like is prevented.

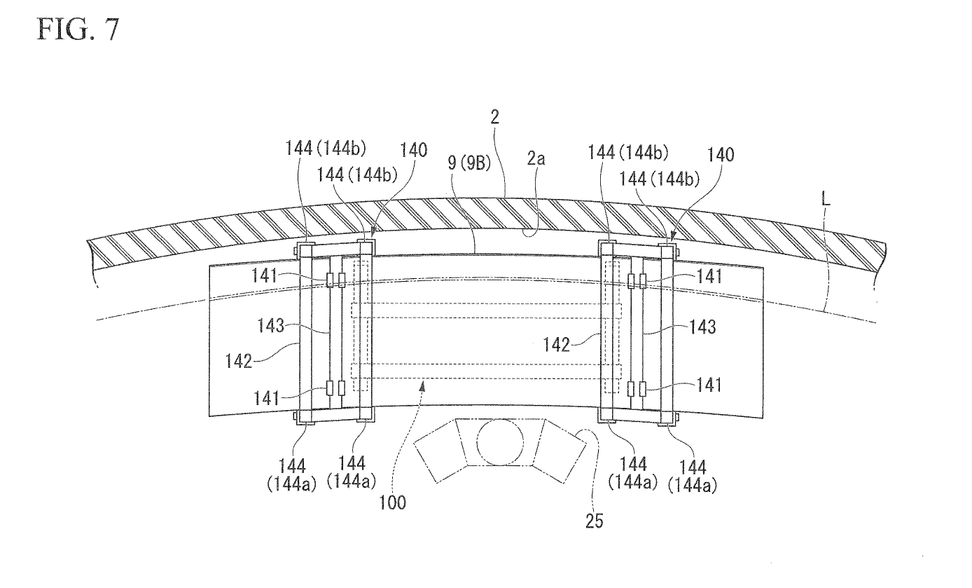

Rails 143 extending in a tank radial direction are built on an upper portion of the movable stand 142 and the trolley cranes 141 can move along the rails 143. With such a constitution, as shown in FIG. 7, hanging points for raising the inner tank lateral plates 9 can be arbitrarily adjusted in the tank radial direction. For this reason, the inner tank lateral plates 9 can be raised along a line L in which the second structure 9B is assembled. Note that since the inner tank lateral plates 9 have a certain amount of length, the raising of the inner tank lateral plate 9 may be performed using the plurality of lifting devices 140. The lifting devices 140 may move individually, or groups of the lifting devices 140 for raising the inner tank lateral plate 9 may be unitized to move integrally.

By adopting the above-described methods, without using the trolley cranes 21, the inner tank lateral plates 9 can be conveyed in the tank circumferential direction and stand on the annular portion 13, the adjacent inner tank lateral plates 9 can be welded, and thus the second structure 9B can be assembled.

### Second Embodiment

In the above-described embodiment, the inner tank lateral plates 9 are assembled on the outer peripheral edge portion of the inner tank roof 14, which is assembled on the roof stand 7, via the knuckle plates 11, and the outer tank roof 22 is assembled on the inner tank roof 14 and is formed integrally with the inner tank roof 14. Therefore, the outer tank roof 22 is also raised simultaneously with the raising of the inner tank lateral plates 9 using the jack-up units 18.

However, this disclosure may be applied to a method for constructing a cylindrical tank in which raising of inner tank lateral plates and raising of an outer tank roof are independently performed.

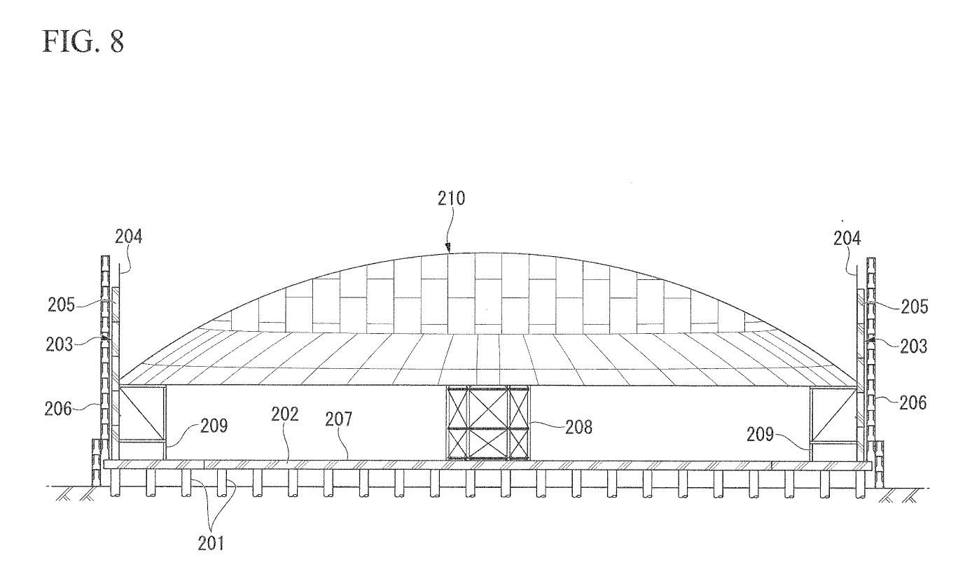

An example of the method for constructing the cylindrical tank described above is shown in FIGS. 8 to 18.

In this example, as shown in FIG. 8, first, bearing piles 201 are driven into the ground and a portion of a base slab 202 is constructed thereon. Subsequently, a PC wall (an outer tank) 203 is erected on an annular portion of the constructed base slab 202. To be specific, lateral liners 204 are built on the base slab 202 and concrete 205 is poured outside the lateral liners 204 to erect the PC wall 203. The lateral liners 204 are steel liners and also serve as molds for pouring concrete. External foot scaffolds 206 are installed, the lateral liners 204 are built, and the concrete 205 is poured so as to follow the building of the lateral liners 204. Thus, the PC wall 203 is sequentially built from the bottom.

After a central portion of the base slab 202 which is a portion more inner than the annular portion of the base slab 202 is constructed, the base slab 202 is completed. After the base slab 202 has been completed, a bottom liner 207 is laid thereon. Subsequently, a roof stand 208 is assembled on the central portion of the base slab 202.

Subsequently, legged trestles 209 are installed along insides of proximal ends of the lateral liners 204. Furthermore, an outer tank roof 210 is assembled on the roof stand 208 and the legged trestles 209. The outer tank roof 210 is assembled by, for example, placing a high-elevation work vehicle or the like onto the base slab 202, building a steel frame, and mounting roof blocks on top of the steel frame. Because the outer tank roof 210 is assembled in an area away from the outer peripheral edge portion of the base slab 202 on which the PC wall 203 is being built, the building of the PC wall 203 does not interfere with the assembly of the outer tank roof 210 and both tasks can be simultaneously performed.

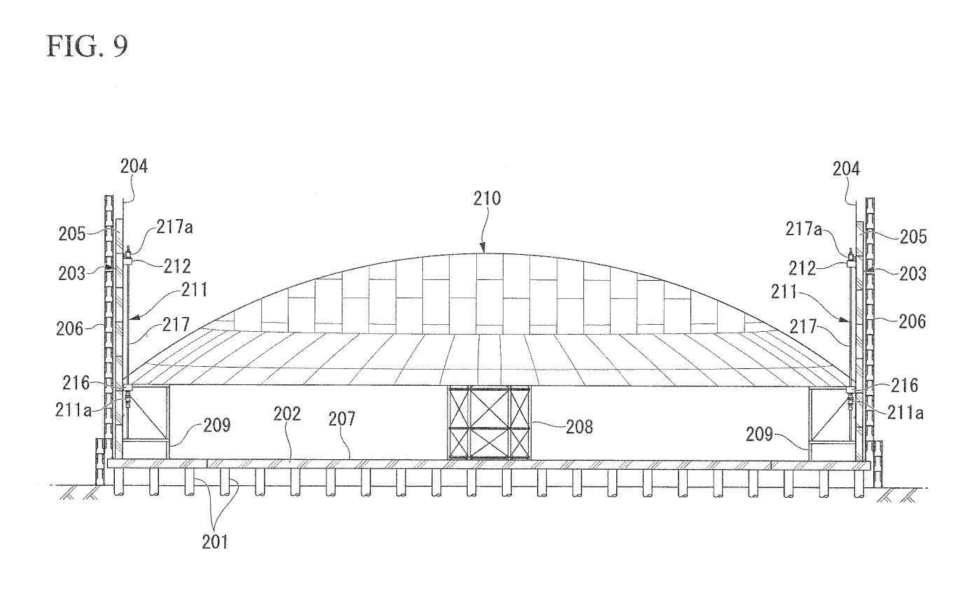

Once the outer tank roof 210 is assembled to some extent, subsequently, as shown in FIG. 9, jack-up units 211 are installed at the PC wall 203 which is in the course of assembly. First, a plurality of hanging-side jack stands 212 are installed at the PC wall 203 in the tank circumferential direction above the base slab 202 and above the outer peripheral edge portion of the outer tank roof 210. The hanging-side jack stands 212 are installed so as to protrude substantially horizontally from the PC wall 203 at a predetermined height toward an inside of the tank.

Subsequently, a plurality of hanged-side jack stands 216 corresponding to the plurality of hanging-side jack stands 212 are installed at the outer peripheral edge portion of the outer tank roof 210. The hanged-side jack stands 216 are installed so as to protrude substantially horizontally from the outer peripheral edge portion of the outer tank roof 210 toward an outside of the tank. The hanged-side jack stands 216 are detachably fixed to the outer peripheral edge portion of the outer tank roof 210.

Note that the hanged-side jack stands 216 may be installed at the top of the outer tank roof 210 rather than at the lateral portion of the outer tank roof 210 as shown in FIG. 9.

Also, the plurality of jack-up units 211 are installed at predetermined intervals in the tank circumferential direction between the hanging-side jack stands 212 and the hanged-side jack stands 216. The jack-up units 211 are configured as center hall jacks, and have cylindrical jack bodies 211a suspended under the hanged-side jack stands 216, and vertically extending jack-up rods 217 which are held in the jack bodies 211a in a state where the jack-up rods 217 are vertically movable and upper ends of which are engaged with the hanging-side jack stands 212 via equalizers 217a.

Note that, after a roof steel frame part of the outer tank roof 210 is built, the roof stand 208 can be removed, and after the jack-up units 211 are installed as described above, some of the legged trestles 209 can be removed. When the roof stand 208 and some of the legged trestles 209 are removed, a weight of the outer tank roof 210 is supported by the plurality of jack-up units 211.

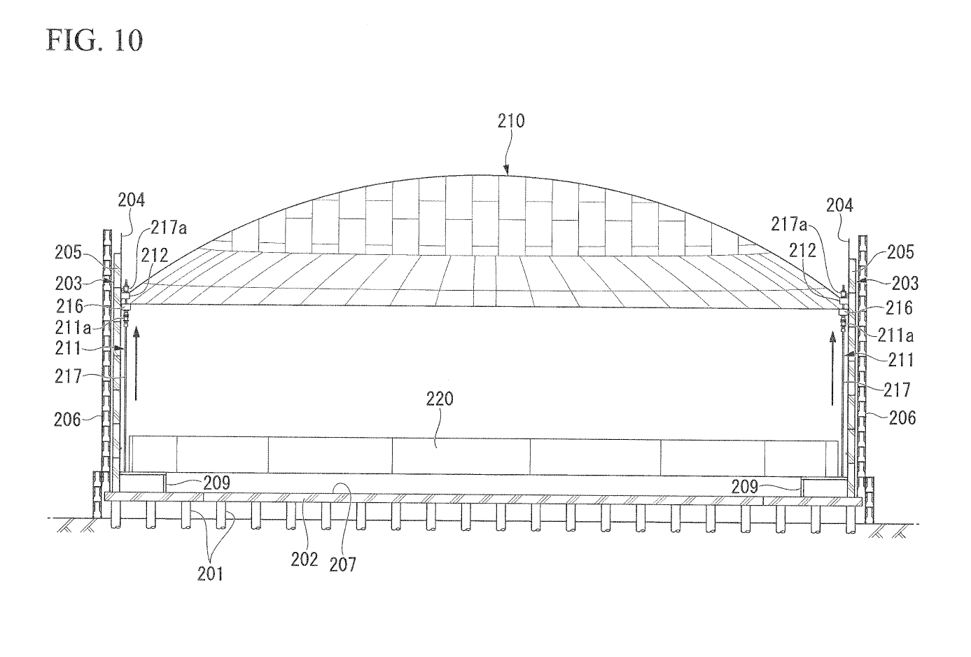

Subsequently, as shown in FIG. 10, the outer tank roof 210 assembled above the base slab 202 is raised using the jack-up units 211. To be specific, when the jack bodies 211a are driven in forward rotation, the jack bodies 211a together with the hanged-side jack stands 216 are raised while being guided by the jack-up rods 217, and the outer tank roof 210 which is in the course of assembly is jacked up. By jacking up the outer tank roof 210, a work space in which inner tank lateral plates 220 are loaded and an inner tank is assembled can be secured below the outer tank roof 210.

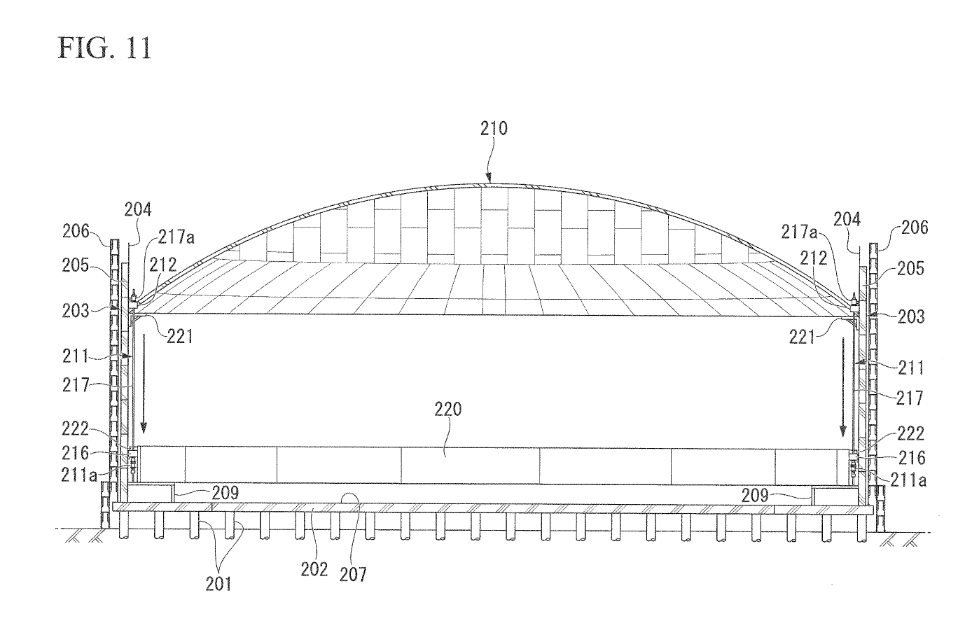

Subsequently, as shown in FIG. 11, the outer tank roof 210 raised by the jack-up units 211 is held by the PC wall 203. To be specific, the outer tank roof 210 is held by the PC wall 203 via holding stands 221 installed in the middle stage of the PC wall 203. The holding stands 221 are installed so as to protrude substantially horizontally from the PC wall 203 at a predetermined height toward the inside of the tank. The holding stands 221 are firmly and detachably fixed to, for example, anchor plates or the like embedded in the PC wall 203 in advance.

Once the holding stands 221 are installed, the fixing of the hanged-side jack stands 216 to the outer tank roof 210 is released. When the fixing of the hanged-side jack stands 216 is released, the weight of the outer tank roof 210 is supported by the holding stands 221. As described above, when the outer tank roof 210 is held by the PC wall 203 via the holding stands 221, the jack bodies 211a are driven to rotate rearward and are lowered to the vicinity of the base slab 202. Thereby, a space below the outer tank roof 210 can be used for an assembly task of the inner tank lateral plates 220.

At the time of assembly of the inner tank, as shown in FIG. 11, first, a plurality of inner tank lateral plates (which form sidewalls of the inner tank) 220 are erected on the legged trestles 209 in the tank circumferential direction. Furthermore, the inner tank lateral plates 220 adjacent to each other in a horizontal direction are integrally welded so that the inner tank lateral plates 220 are annularly assembled. Note that the inner tank lateral plates 220 assembled herein correspond to the uppermost level (to the eighth row in this embodiment).

Subsequently, a plurality of hanged-side attaching stands 222 corresponding to the plurality of hanged-side jack stands 216 are installed at the annularly assembled inner tank lateral plates 220. The hanged-side attaching stands 222 are installed so as to protrude substantially horizontally from the outer peripheral surface of the annularly assembled inner tank lateral plates 220 toward the outside of the tank. The hanged-side jack stands 216 of the jack-up units 211 are detachably fixed to the hanged-side attaching stands 222. As a result, all or some of a weight of the inner tank lateral plates 220 that have been annularly assembled as described above is supported by the jack-up units 211. Furthermore, in order to prevent deformation of the inner tank lateral plates 220, an appropriate auxiliary member may be provided on at least one of inside and outside of the inner tank lateral plates 220 as necessary.

Note that, the hanged-side jack stands 216 may be separately attached to the inner tank lateral plates 220, or the hanged-side jack stands 216 attached to the outer tank roof 210 may be diverted to the hanged-side jack stands 216 attached to the inner tank lateral plates 220.

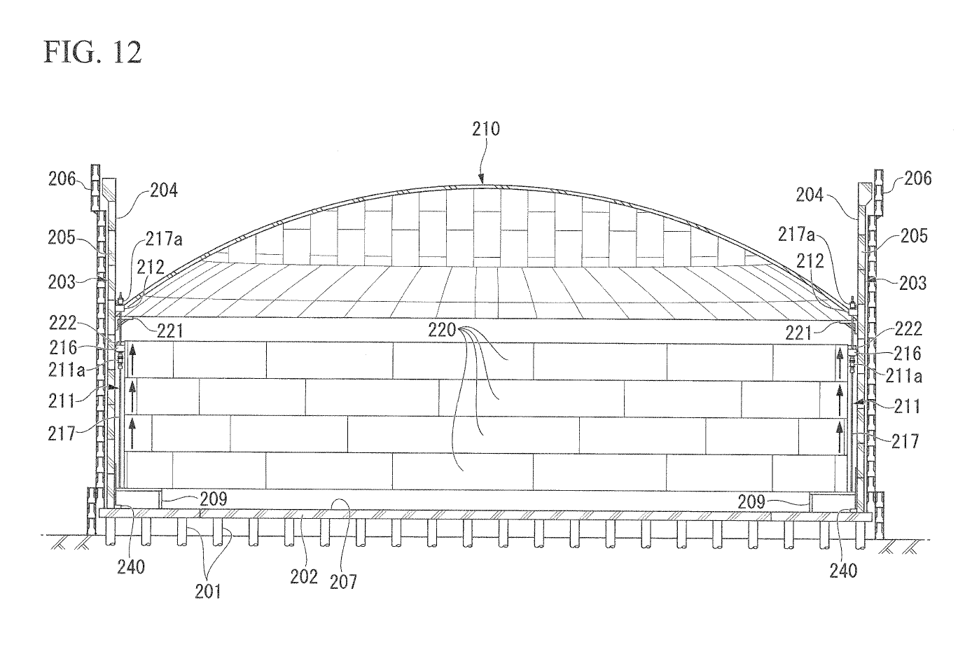

Subsequently, as shown in FIG. 12, raising of the inner tank lateral plates 220 using the jack-up units 211 and attaching of the next inner tank lateral plate below the raised inner tank lateral plates 220 are alternately and repeatedly performed to assemble the inner tank. To be specific, first, the jack-up units 211 are jacked up so that the annularly assembled inner tank lateral plates 220 are raised by an amount corresponding to a vertical width of a single inner tank lateral plate 220. Subsequently, the next inner tank lateral plates 220 are loaded into a space formed below the jacked-up inner tank lateral plates 220 via a construction site entrance (not shown in the figure) provided in the PC wall 203. In addition, the next inner tank lateral plates 220 are lowered on the legged trestles 209 and are annularly disposed below the jacked-up inner tank lateral plates 220.

Also, the plurality of annularly disposed inner tank lateral plates 220 are welded and the vertically arranged inner tank lateral plates 220 are welded so that the inner tank lateral plates 220 are integrally formed in a cylindrical shape.

Note that the plurality of inner tank lateral plates 220 may be joined together in the horizontal direction in advance outside the tank, be loaded into the tank, and be formed in an annular shape, and the vertically arranged inner tank lateral plates 220 may be then welded together. In this case, by performing the task of joining the plurality of inner tank lateral plates 220 together outside the PC wall 203 where there are few limitations on the working space, the welding task is made easier, and the inner tank can be assembled efficiently.

Thus, the raising of the inner tank lateral plates 220 using the jack-up units 211 and the attaching of the next inner tank lateral plates 220 below the raised inner tank lateral plates 220 are alternately and repeatedly performed and the next inner tank lateral plates 220 are added below the inner tank lateral plates 220 so that the adding of the inner tank lateral plates 220 is performed at a low position near the base slab 202. For this reason, a safe assembly task of the inner tank at a low place can be performed while interference of the inner tank lateral plates 220 with the outer tank roof 210 held in the middle stage of the PC wall 203 is avoided.

During this process, the assembly of the outer tank roof 210 which is in the course of assembly and is held by the PC wall 203 is also performed. To be specific, before the outer tank roof 210 is finally settled on the top of the PC wall 203, the outer tank roof 210 is held at the middle stage of the PC wall 203, and in this state, the outer tank roof 210 is assembled just before its completion. This assembly includes displacement of reinforcing bars for pouring roof concrete. In this embodiment, the task of displacing the reinforcing bars starts when the outer tank roof 210 is at the middle stage. Thus, in this embodiment, after the building of the PC wall 203 has been completed, the outer tank roof 210 is settled on the top of the PC wall 203 and thereby the outer tank can be rapidly completed.

In this method, the PC wall 203 is built on the outer peripheral edge portion of the base slab 202 as described above, and in parallel with the building of the PC wall 203, the outer tank roof 210 is assembled in the area above the base slab 202 away from the outer peripheral edge portion. Furthermore, after the outer tank roof 210 is assembled to some extent, the outer tank roof 210 is raised using the jack-up units 211 and is held by the PC wall 203 which is in the course of assembly. Thus, a space used to assemble the inner tank is secured below the outer tank roof 210 and thus the inner tank can be assembled independently from the outer tank roof 210. Therefore, according to this embodiment, the building of the PC wall 203, the assembly of the outer tank roof 210, and the assembly of the inner tank are simultaneously and concurrently performed and thus the construction period can be significantly shortened.

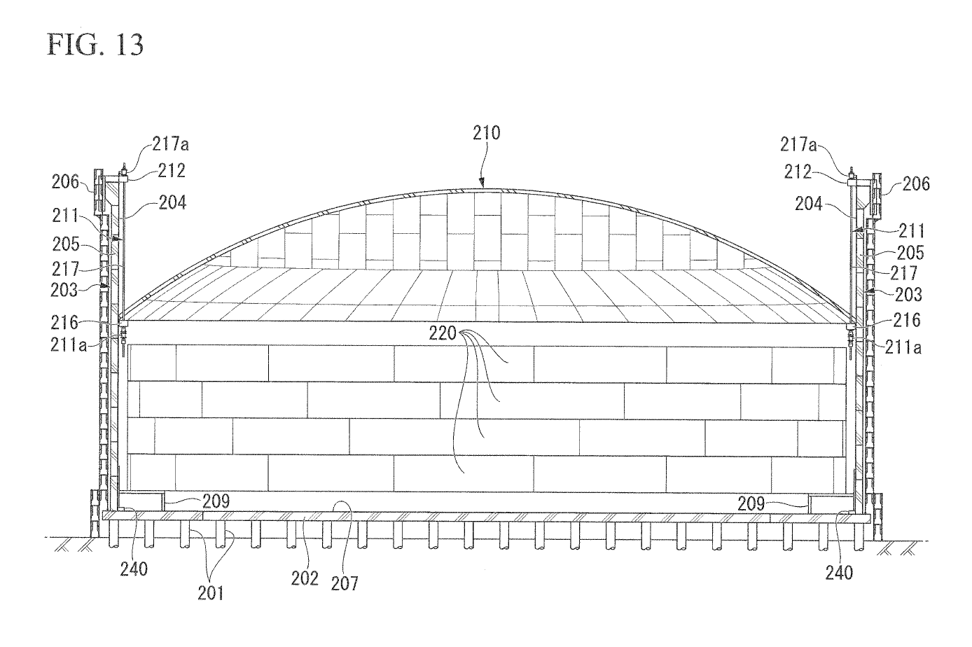

In addition, in this method, as shown in FIG. 13, thermal corner protections 240 for preventing leakage of tank content can be provided at the annular portion positioned between the inner and outer tanks. The thermal corner protections 240 are made of cellular glass, perlite concrete blocks, or the like, and are constructed using a space below the legged trestles 209. Note that although the thermal corner protections 240 are members configured to protect corners, and the thermal corner protections 240 are continuously constructed at the corners as well as an inside of the base slab 202 along the base slab 202.

After the PC wall 203 has been completed, subsequently, as shown in FIG. 13, the jack-up units 211 are provided on the top of the PC wall 203. To be specific, the fixing of the hanging-side jack stands 212 to the middle stage of the PC wall 203 is released, the hanging-side jack stands 212 are fixed to the top of the PC wall 203 via temporary stands, the fixing of the hanged-side jack stands 216 to the inner tank lateral plates 220 is released, and the hanged-side jack stands 216 are fixed to the outer peripheral edge portion of the outer tank roof 210. Furthermore, the jack-up units 211 are installed between the hanging-side jack stands 212 and the hanged-side jack stands 216. Once the jack-up units 211 are installed as described above, the holding stands 221 can be removed. Thus, the holding stands 221 are removed later at an appropriate time.

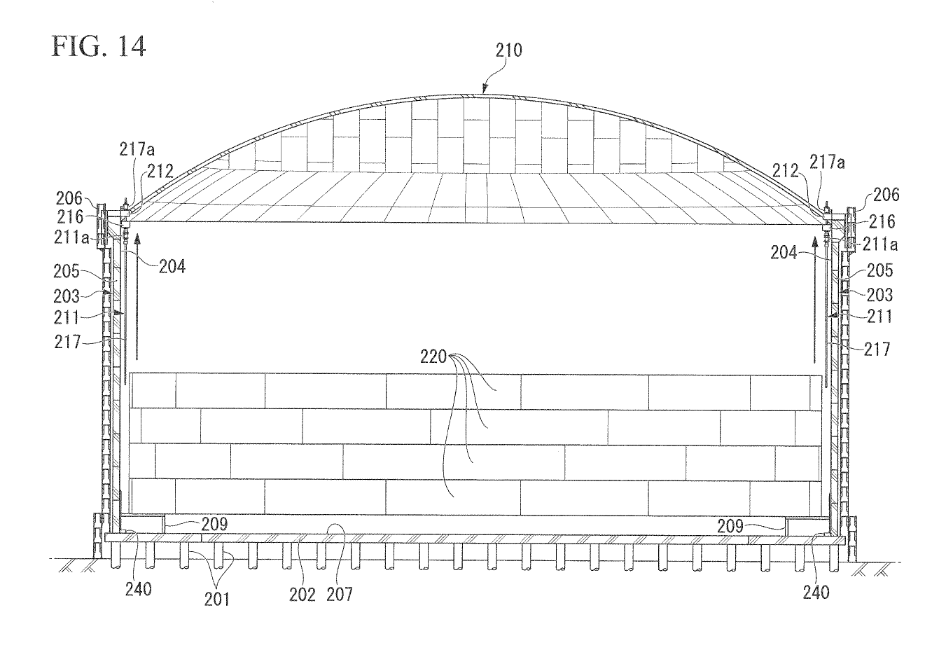

Subsequently, as shown in FIG. 14, the outer tank roof 210 is raised using the jack-up units 211 and is settled on the top of the PC wall 203. If the jack-up units 211 are installed at the lateral portion of the PC wall 203 to raise the outer tank roof 210 held in the middle stage of the PC wall 203, concrete parts of the outer tank roof 210 cannot be installed at places of the jack-up units 211. For this reason, in this method, the jack-up units 211 are provided on the top of the PC wall 203, couplers (not shown in the figure) are provided on the inner peripheral surface of the PC wall 203, and the concrete parts of the outer tank roof 210 are installed at the couplers.

With such a connection structure using the couplers, the task of displacing the reinforcing bars in the outer tank roof 210 can be stated in a state where the outer tank roof 210 is held in the middle stage of the PC wall 203 as shown in FIGS. 11 and 12, and after the PC wall 203 has been built, the outer tank roof 210 can be rapidly settled on the top of the PC wall 203 by connecting the reinforcing bars to the couplers in the outer tank roof 210. In other words, by using the couplers, the task of displacing the reinforcing bars in the outer tank roof 210 can be started when the outer tank roof 210 is at the middle point. As a result, a start time of forming an on-roof structure which will be described later is inevitably quickened.

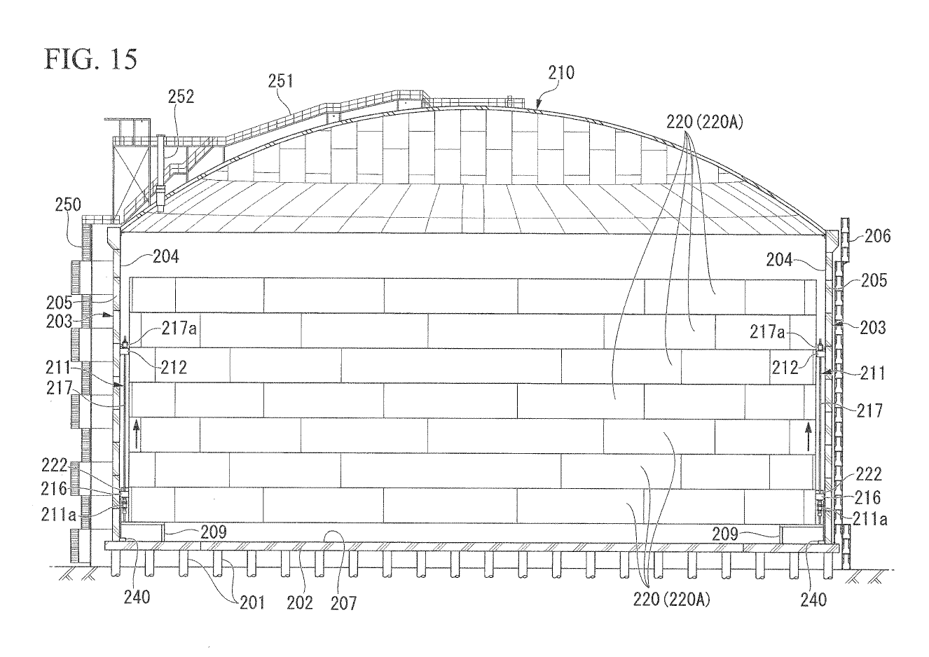

After the outer tank roof 210 has been settled on the PC wall 203, subsequently, as shown in FIG. 15, the jack-up units 211 are provided in the middle stage of the PC wall 203. Furthermore, a first structure 220A of the inner tank lateral plates 220 excluding the lowermost level is assembled using the jack-up units 211. To be specific, as described above, the raising of the inner tank lateral plates 220 using the jack-up units 211 and the attaching of the next inner tank lateral plates 220 below the raised inner tank lateral plates 220 are alternately and repeatedly performed, and the first structure 220A of the inner tank lateral plates 220 excluding the lowermost level is sequentially assembled from the uppermost level to lower levels, and then the first structure 220A is jacked up.

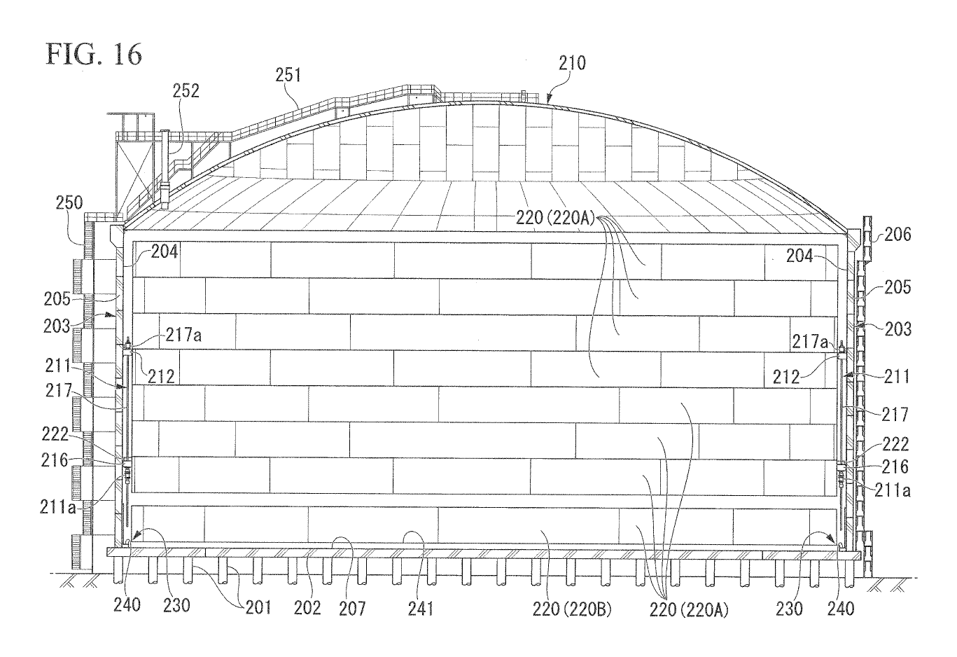

Subsequently, as shown in FIG. 16, the legged trestles 209 are removed and a cold insulation task of laying a cold insulation member 241 on the base slab 202 is performed. The cold insulation member 241 is formed, for example, by providing cellular glass on a bottom cold-resistant relaxation member laid on the base slab 202, providing rigid lightweight aerated concrete, perlite concrete blocks, structural lightweight concrete blocks or the like at a portion (an annular portion 230) on which the inner tank will be installed, and laying an inner tank bottom plate (not shown in the figure) thereon.

Also, as shown in FIG. 16, below the jacked-up first structure 220A, the lowermost level of the inner tank lateral plates 220 is assembled on the annular portion 230 of the inner tank bottom plate separately from the first structure 220A. Once the lowermost level of the inner tank lateral plates 220 is placed on the annular portion 230, the adjacent inner tank lateral plates 220 are welded, the inner tank lateral plates 220 are joined together in the circumferential direction thereof to be cylindrical as a whole, and thus a second structure 220B is assembled.

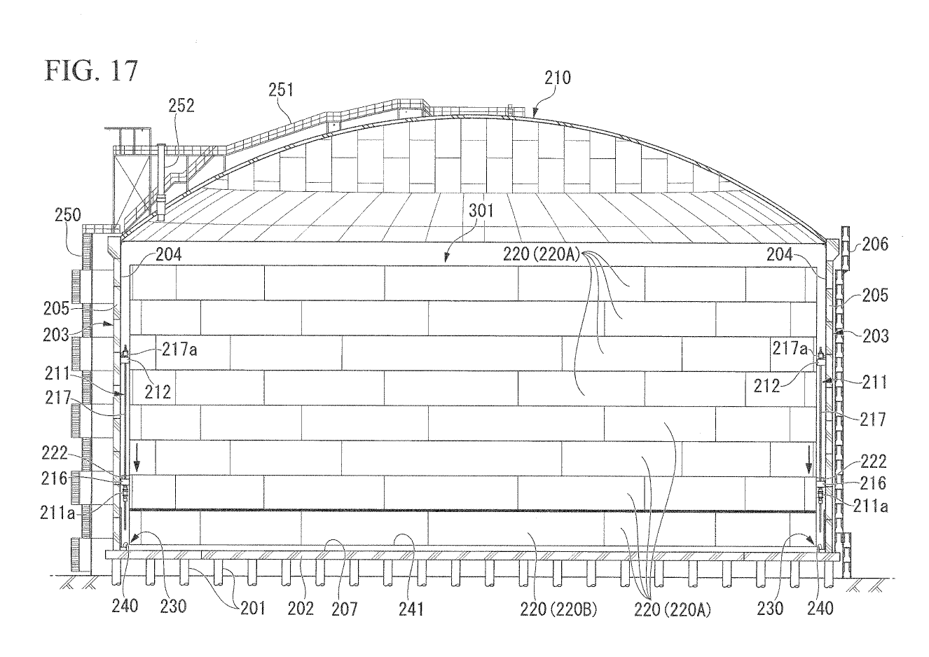

Subsequently, as shown in FIG. 17, the first structure 220A is jacked down so that a lower end of the first structure 220A is lowered on an upper end of the second structure 220B, the first structure 220A is welded to the second structure 220B, and thus an inner tank 301 is assembled. In this method, assembly of the lowermost level of the inner tank 301 is separated from assembly of the inner tank 301 using the jack-up units 211 and fixing of the second structure 220B serving as the lowermost level of the inner tank 301 onto the annular portion 230 is performed ahead of schedule (refer to FIG. 16). Therefore, in this method, fixing of the inner tank 301 onto the annular portion 230, which takes, for example, about one month, is not a critical path, and thus the construction period can be shortened as compared with a method in the related art.

After the first structure 220A has been lowered on the second structure 220B, the jack-up units 211 are removed.

Also, a staircase 250 is provided along the PC wall 203, an on-roof structure 251, a well nozzle 252, and the like are provided on the outer tank roof 210, and concrete is poured over the outer tank roof 210. Note that in order to perform a construction task on the outer tank roof 210 as soon as possible, pouring of concrete may be performed immediately after the reinforcing bars in the outer tank roof 210 are connected to the couplers.

Subsequently, a tension task is performed on the PC wall 203. Then, after the pump well 253 is installed and the inner tank construction site entrance (not shown in the figure) is closed, a pressure resistance/air-tightness test is performed by filling the tank with water. Note that the installing of the pump well 253 is normally performed prior to closing of the inner tank construction site entrance (not shown in the figure), however, this installation can be set to any desired point in time.

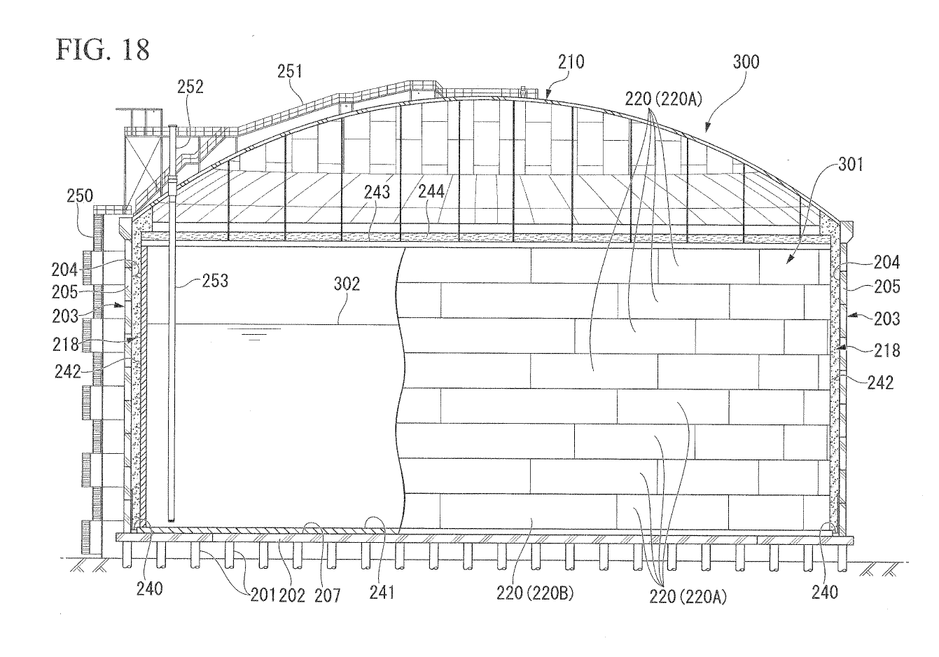

Finally, as shown in FIG. 18, a cold insulation task between the inner and outer tanks is performed by filling a space 218 between inner and outer tanks with a cold insulation material 242 (for example, with perlite). In addition, a cold insulation task on an underside of the outer tank roof 210 is performed by laying a cold insulation material 244 (for example, glass wool) on a suspension deck 243 provided in the underside of the outer tank roof 210.

After that, through a painting task and a piping cold insulation task, construction of a cylindrical tank 300 configured to accumulate liquefied natural gas (LNG) 302 is completed.

As described above, this embodiment is a method for constructing the double-shell-structured cylindrical tank 300 having the inner tank and the outer tank, and the method includes: a step of, inside the PC wall 203, assembling the first structure 220A of the inner tank 301 excluding the lowermost level of the inner tank 301 by alternately and repeatedly performing raising of the inner tank lateral plates 220 using the jack-up units 211 and attaching of the next inner tank lateral plates 220 below the raised inner tank lateral plates 220; a step of assembling the second structure 220B serving as the lowermost level of the inner tank 301 on the annular portion 230 provided on the base slab 1 and configured to support the inner tank 301; and a step of assembling the inner tank 301 by joining the first structure 220A and the second structure 220B. Thus, since installing of the lowermost level of the inner tank 301 on the inner tank bottom plate can be performed ahead of schedule, installing of the inner tank 301 onto the inner tank bottom plate is not a critical path, and thus the construction period can be shortened.

Note that, as a step of assembling the second structure 220B, the above-described step illustrated in FIGS. 5 to 7 can be used. In this case, the conveying device 100 is provided on the annular portion 230 and the inner tank lateral plates 220 of the second structure 220B are conveyed in the tank circumferential direction (this will not be described in detail because it is the same as the description of FIGS. 5 to 7 in the first embodiment).

Although preferable embodiments of this disclosure have been described above with reference to the drawings, this disclosure is not limited the above-described embodiments. Shapes, combinations, and the like of constituent elements illustrated in the above-described embodiments are examples and various modifications are possible on the basis of design requirements without departing from the gist of this disclosure.

### INDUSTRIAL APPLICABILITY

The construction period of a method for constructing a cylindrical tank can be shortened.

What is claimed is:

1. A method for constructing a double-shell-structured cylindrical tank having an inner tank and an outer tank, the method for constructing the cylindrical tank comprising:
a step of, inside the outer tank, assembling a first structure of the inner tank excluding a lowermost level of the inner tank by alternately and repeatedly performing raising of an inner tank lateral plate using a jack-up unit and attaching of a next inner tank lateral plate below the raised inner tank lateral plate;
a step of assembling a second structure serving as the lowermost level of the inner tank on an annular portion provided on a base portion of the outer tank and configured to support the inner tank; and
a step of assembling the inner tank by joining the first structure and the second structure.

2. The method for constructing the cylindrical tank according to claim 1, further comprising:
a step of conveying an inner tank lateral plate of the second structure in a tank circumferential direction using a conveying device traveling on the base portion of the outer tank.

3. The method for constructing the cylindrical tank according to claim 2, wherein the conveying device has a supporting part configured to diagonally support the inner tank lateral plate of the second structure.

4. The method for constructing the cylindrical tank according to claim 3, further comprising:
a step of standing the inner tank lateral plate of the second structure diagonally supported on the annular portion using a lifting device configured to travel on the base portion of the outer tank.

5. The method for constructing the cylindrical tank according to claim 4, wherein the lifting device includes a gate type movable stand which crosses over a traveling route of the conveying device.
